(19) United States
(12) Patent Application Publication
(10) Pub. No.: US 2026/0120077 A1
(43) Pub. Date: Apr. 30, 2026

(54) CHANGING RESTRICTIONS ON VIRTUAL IDENTIFIERS

(71) Applicant: Capital One Services, LLC, McLean, VA (US)

(72) Inventors: Jackson MACOMBER, Henrico, VA (US); Jeffrey RULE, Chevy Chase, MD (US); Jeffrey Carlyle WIEKER, Falls Church, VA (US)

(21) Appl. No.: 18/933,106

(22) Filed: Oct. 31, 2024

(51) Int. Cl. G06Q 20/34; G06Q 20/40

(52) U.S. Cl. CPC G06Q 20/351; G06Q 20/405

(57) ABSTRACT

In some implementations, an identifier manager may receive, from a user device, a request to generate a virtual identifier. The request may indicate a target user for the virtual identifier and a permanent identifier to associate with the virtual identifier. The identifier manager may provide an indication of a set of events to a machine learning model to receive a set of restrictions to apply to the virtual identifier. The set of events may be associated with a profile that is similar to a profile of a user of the user device or to a profile of the target user. The identifier manager may transmit, to the user device, an indication of the set of restrictions. The identifier manager may transmit, to an account manager, an instruction to associate the virtual identifier with the permanent identifier and to apply the set of restrictions to the virtual identifier.

### BACKGROUND

To improve security in a computerized system, virtual identifiers may be used in place of permanent identifiers. For example, a virtual card number (VCN) may be used in place of a payment account number (PAN). Tokenizing the PAN into the VCN improves security because the VCN may be replaced, if compromised, more easily than the PAN.

### SUMMARY

Some implementations described herein relate to a system for managing restrictions on a virtual identifier. The system may include one or more memories and one or more processors communicatively coupled to the one or more memories. The one or more processors may be configured to receive, from a user device, a request to generate the virtual identifier, wherein the request indicates a target user for the virtual identifier and a permanent identifier to associate with the virtual identifier. The one or more processors may be configured to determine, using a machine learning model, a set of restrictions to apply to the virtual identifier. The one or more processors may be configured to transmit, to the user device, an indication of the set of restrictions. The one or more processors may be configured to receive, from the user device, an approval of the set of restrictions. The one or more processors may be configured to activate the virtual identifier with the set of restrictions. The one or more processors may be configured to receive an indication of a set of events associated with the virtual identifier. The one or more processors may be configured to provide the indication of the set of events to the machine learning model in order to receive a modified restriction. The one or more processors may be configured to transmit, to the user device, an indication of the modified restriction. The one or more processors may be configured to receive, from the user device, an approval of the modified restriction. The one or more processors may be configured to apply the modified restriction to the virtual identifier.

Some implementations described herein relate to a method of initiating restrictions on a virtual identifier. The method may include receiving, from a user device and at an identifier manager, a request to generate the virtual identifier, wherein the request indicates a target user for the virtual identifier and a permanent identifier to associate with the virtual identifier. The method may include providing an indication of a set of events to a machine learning model to receive a set of restrictions to apply to the virtual identifier, wherein the set of events are associated with a profile that is similar to a profile of a user of the user device or to a profile of the target user. The method may include transmitting, from the identifier manager and to the user device, an indication of the set of restrictions. The method may include transmitting, from the identifier manager and to an account manager, an instruction to associate the virtual identifier with the permanent identifier and to apply the set of restrictions to the virtual identifier.

Some implementations described herein relate to a non-transitory computer-readable medium that stores a set of instructions for adjusting restrictions on a virtual identifier. The set of instructions, when executed by one or more processors of a device, may cause the device to receive an indication of a set of events associated with the virtual identifier, wherein the virtual identifier is associated with a set of restrictions. The set of instructions, when executed by one or more processors of the device, may cause the device to provide the indication of the set of events to a machine learning model in order to receive a suggested change to the set of restrictions. The set of instructions, when executed by one or more processors of the device, may cause the device to transmit, to a user device, an indication of the suggested change. The set of instructions, when executed by one or more processors of the device, may cause the device to transmit, to an account manager, an instruction to apply the suggested change to the set of restrictions for the virtual identifier.

### BRIEF DESCRIPTION OF THE DRAWINGS

FIGS. 1A-1I are diagrams of an example implementation relating to changing restrictions on virtual identifiers, in accordance with some embodiments of the present disclosure.

FIGS. 2A-2B are diagrams illustrating an example of training and using a machine learning model in systems and/or methods described herein, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to adding restrictions to virtual identifiers, in accordance with some embodiments of the present disclosure.

FIG. 6 is a flowchart of an example process relating to changing restrictions on virtual identifiers, in accordance with some embodiments of the present disclosure.

### DETAILED DESCRIPTION

The following detailed description of example implementations refers to the accompanying drawings. The same reference numbers in different drawings may identify the same or similar elements.

To improve security in a computerized system, virtual identifiers may be used in place of permanent identifiers. For example, a VCN may be used in place of a PAN. Tokenizing the PAN into the VCN improves security because the VCN may be replaced, if compromised, more easily than the PAN. As a result, computer resources are conserved.

However, VCNs are often unbound when created. As a result, security is reduced because a VCN may be used at locations that are more prone to security vulnerabilities. Additionally, computer resources are wasted undoing any fraudulent events (e.g., transactions) performed using the VCN. On the other hand, a set of rules may set a hard expiry for a VCN (e.g., after a particular number of uses and/or on a particular datetime). The set of rules may waste computer resources, however, when the VCN is replaced prematurely.

Some implementations described herein enable a machine learning model to recommend a set of restrictions to apply when generating a virtual identifier. For example, the machine learning model may recommend a cap, a category restriction, a geographic restriction, and/or a merchant restriction to further improve security. As a result, the machine learning model reduces risk of compromise for the virtual identifier, which conserves computer resources that otherwise would have been wasted on undoing fraudulent events (e.g., transactions) performed using the virtual identifier. Additionally, accuracy of the machine learning model may be increased by using a profile, similar to a profile of a user requesting the virtual identifier and/or to a profile of a target user for the virtual identifier, to generate the set of restrictions.

In some implementations, the machine learning model may additionally, or alternatively, recommend a restriction to add to the virtual identifier during use. As a result, the machine learning model reduces risk of compromise for the virtual identifier, which conserves computer resources that otherwise would have been wasted on undoing fraudulent events (e.g., transactions) performed using the virtual identifier. Because the virtual identifier has been used already, the machine learning model may use a set of events (e.g., transactions) associated with the virtual identifier to further improve accuracy, as compared to only using a similar profile.

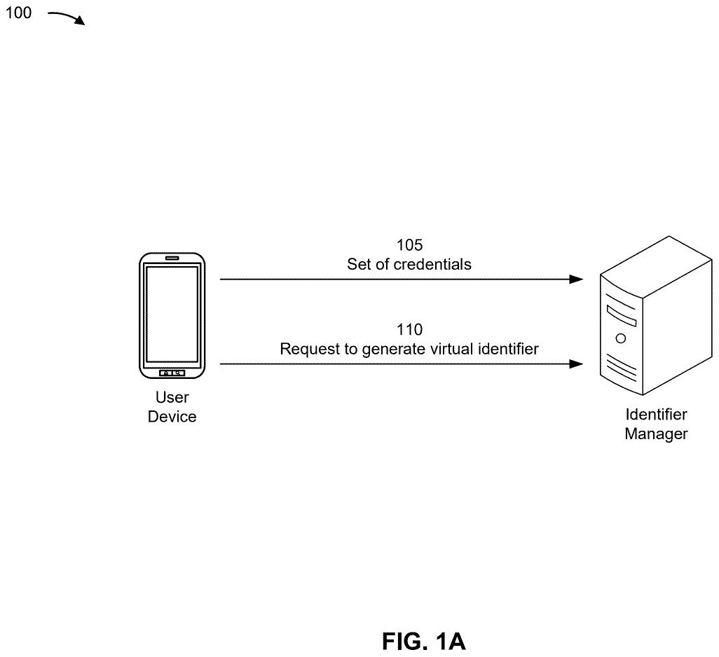

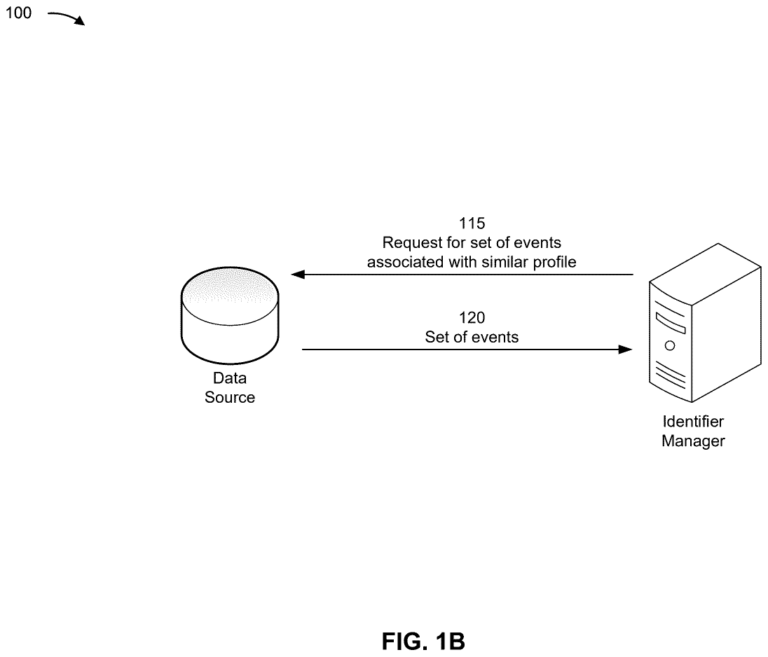

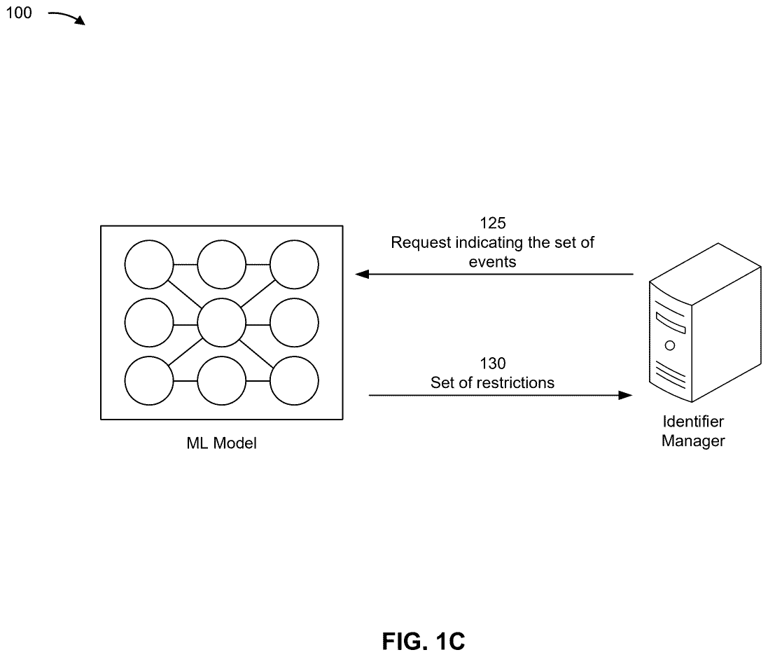

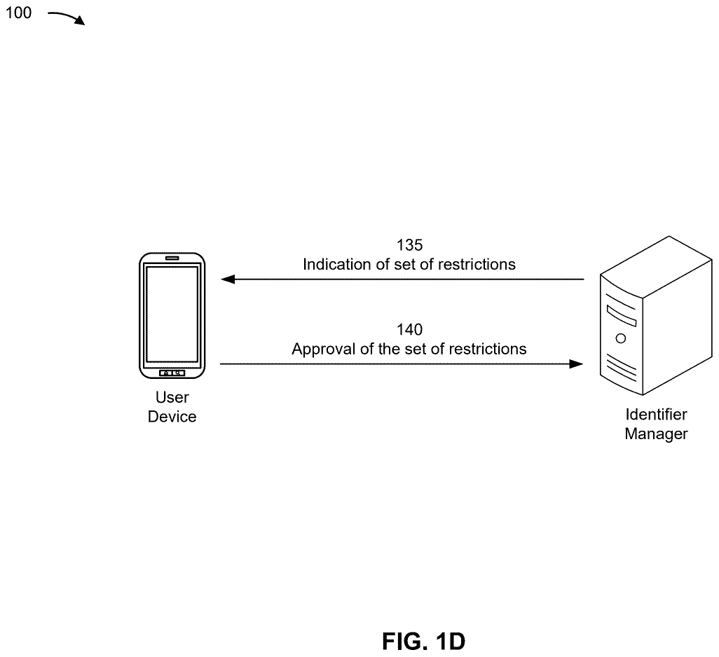

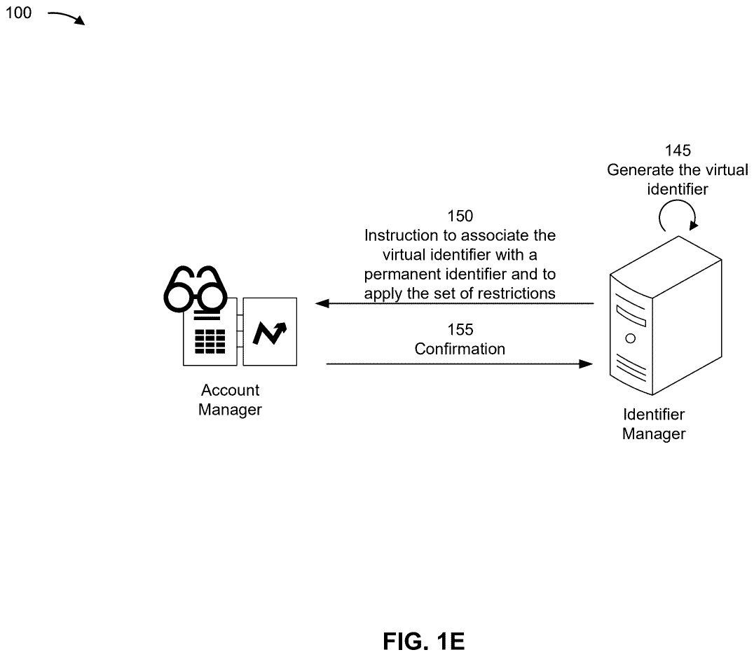

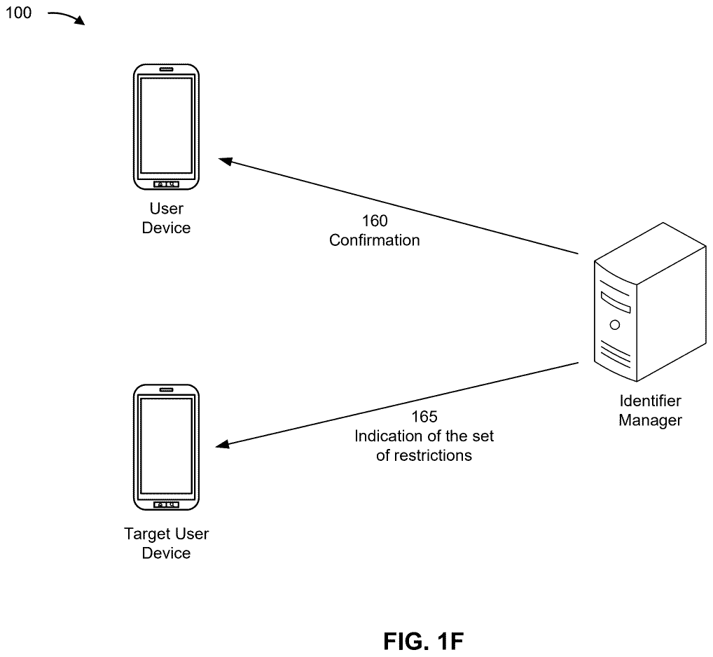

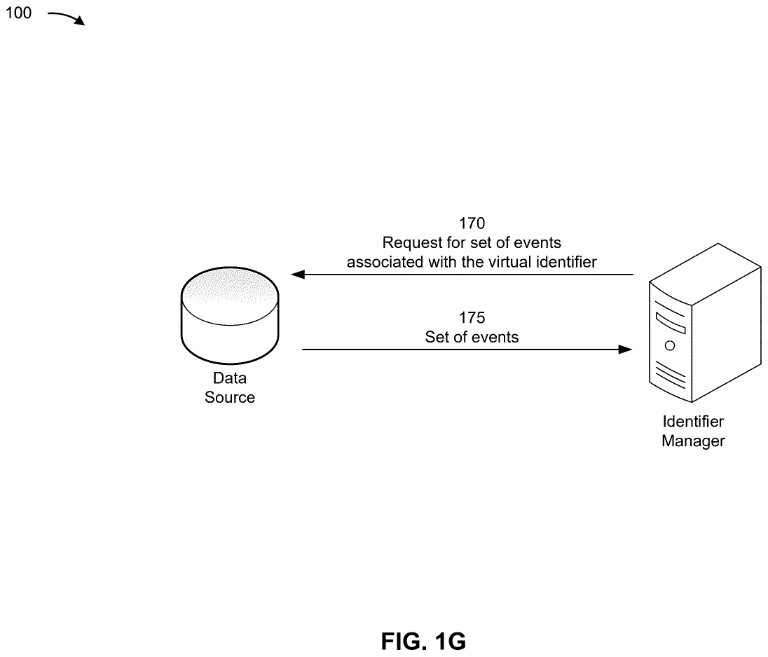

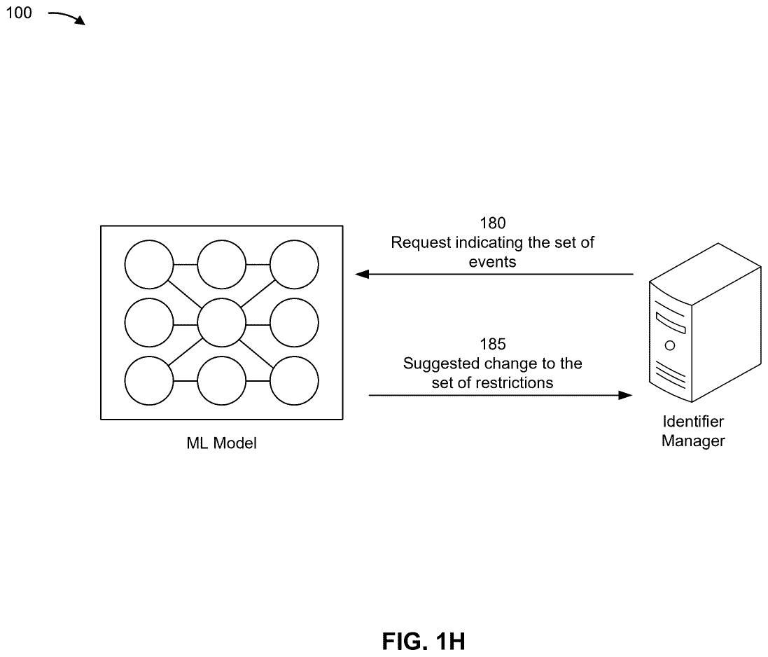

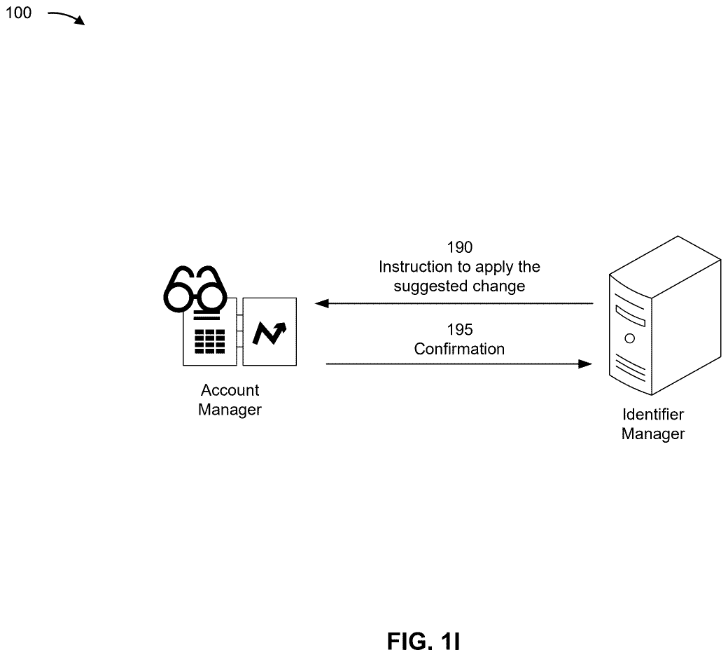

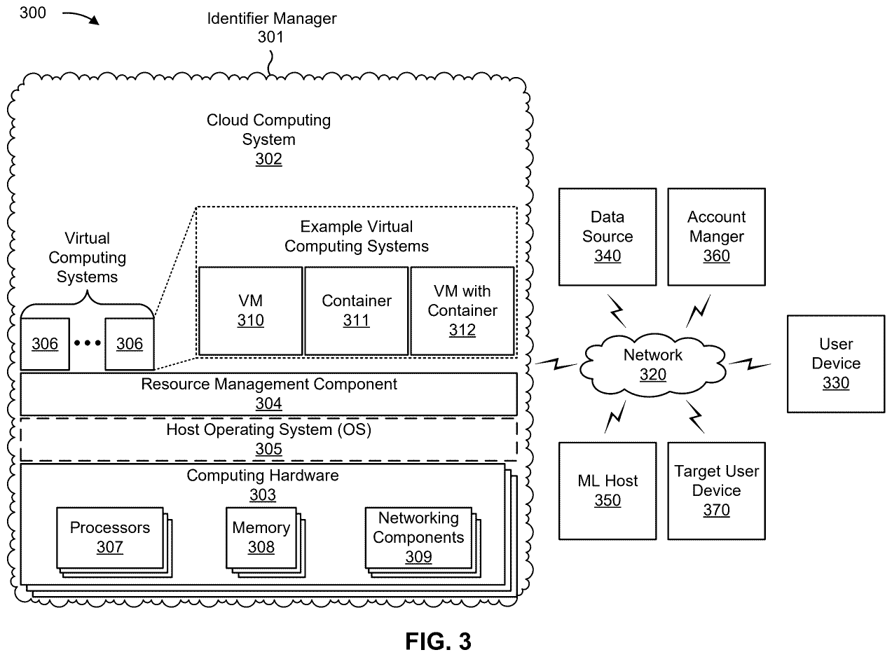

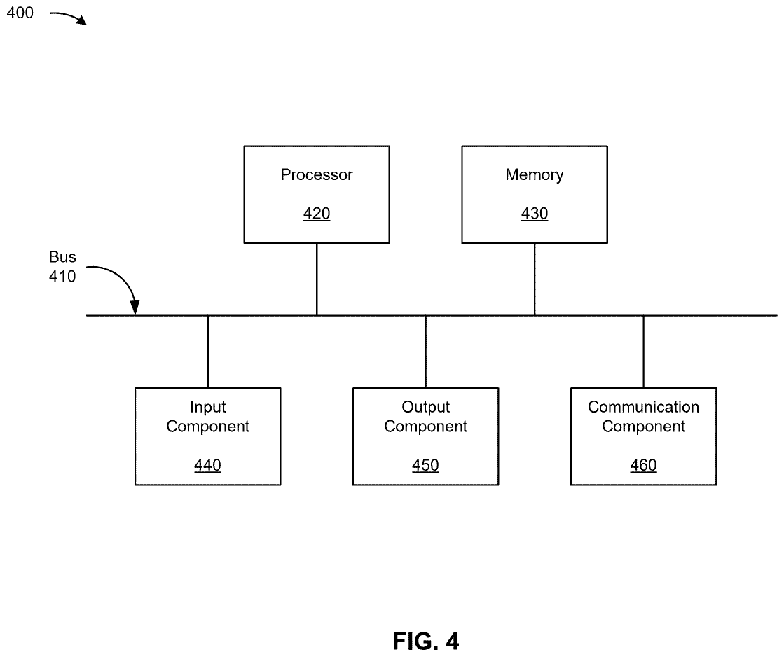

FIGS. 1A-1I are diagrams of an example 100 associated with changing restrictions on virtual identifiers. As shown in FIGS. 1A-1I, example 100 includes a user device, an identifier manager, a data source, a machine learning (ML) model (e.g., provided by an ML host), an account manager, and a target user device. These devices are described in more detail in connection with FIGS. 3 and 4.

As shown in FIG. 1A and by reference number 105, the user device may transmit, and the identifier manager may receive, a set of credentials. The set of credentials may be associated with a user of the user device. The set of credentials may include a username and password, a passcode, a private key, a signature, a certificate, a token, and/or biometric information, among other examples. In some implementations, the user may provide input (e.g., using an input component of the user device) that triggers the user device to transmit the set of credentials. For example, the user device may output (e.g., using an output component of the user device) a user interface (UI) to the user, and the user may interact with the UI in order to provide the input that triggers the user device to transmit the set of credentials. In some implementations, a web browser (or another type of application) executed by the user device may generate the UI. For example, the web browser may navigate to a website controlled by (or at least associated with) the identifier manager, and the web browser may output the UI to represent (at least a portion of) the website. Therefore, the user may interact with the website in order to provide the input that triggers the user device to transmit the set of credentials.

As shown by reference number 110, the user device may transmit, and the identifier manager may receive, a request to generate a virtual identifier. The identifier manager may accept the request based on verifying the set of credentials (associated with the user of the user device). The request may indicate a target user for the virtual identifier. For example, the request may include a name, an email address, and/or a phone number associated with the target user, among other examples. Additionally, the request may indicate a permanent identifier to associate with the virtual identifier. For example, the request may include a token including an encrypted version of the permanent identifier. In another example, the request may include an index or another type of identifier that indicates the permanent identifier from a set of possible permanent identifiers (e.g., from a set of accounts controlled by the user). Alternatively, the request may indicate the permanent identifier implicitly rather than explicitly. For example, the request may be associated with the set of credentials, and the set of credentials may be associated with the permanent identifier (e.g., at a data structure stored, or at least accessible, by the identifier manager).

In some implementations, the user may provide input (e.g., using an input component of the user device) that triggers the user device to transmit the request. For example, the user device may output (e.g., using an output component of the user device) a UI to the user, and the user may interact with the UI in order to provide the input that triggers the user device to transmit the request. In some implementations, the user may interact with a text box to input an indication of the target user. Similarly, the user may interact with a set of radio buttons to select the permanent identifier (e.g., from a set of accounts controlled by the user).

In the example 100, the identifier manager receives the request to generate the virtual identifier based on verifying the set of credentials. Other examples may include different processes for validating the user of the user device. Therefore, the identifier manager may process the request in response to verifying the set of credentials. For example, the user device may include the set of credentials with the request. Alternatively, the user device may transmit the request, the identifier manager may prompt the user device for the set of credentials in response to the request, the user device may transmit the set of credentials in response to the prompt, and the identifier manager may process the request in response to verifying the set of credentials.

As shown in FIG. 1B, the identifier manager may identify a profile to use to generate recommended or suggested restrictions for the virtual identifier. For example, the identifier manager may determine a profile that is similar to a profile of a user of the user device and/or to a profile of the target user. Herein, two profiles may be described as “similar” based on a distance between mathematical representations of the two profiles satisfying a similarity threshold. The mathematical representations may be vectors or matrices, among other examples, and the distance may be a Euclidean distance or a Chebyshev distance, among other examples. The profiles may include demographic information (e.g., race, age, and/or gender), socioeconomic information (e.g., income and/or net worth), or geographic information (e.g., a home address, a work address, and/or common travel destinations), among other examples.

As shown by reference number 115, the identifier manager may transmit, and the data source may receive, a request for a set of events that is associated with the profile similar to the profile of the user of the user device and/or to the profile of the target user. The set of events may include a set of transactions associated with the similar profile. For example, the identifier manager may request anonymized (or at least quasi-anonymized) events authorized by a user associated with the similar profile. The request may include a hypertext transfer protocol (HTTP) request, a file transfer protocol (FTP) request, and/or an application programming interface (API) call.

As shown by reference number 120, the data source may transmit, and the identifier manager may receive, an indication of the set of events. The data source may transmit, and the identifier manager may receive, the indication of the set of events in response to the request (from the identifier manager). The indication may include a table (or another type of structured query language (SQL) data structure) or a graph (or another type of NoSQL data structure). The indication may be included in an HTTP response, included in an FTP response, and/or returned from an API function.

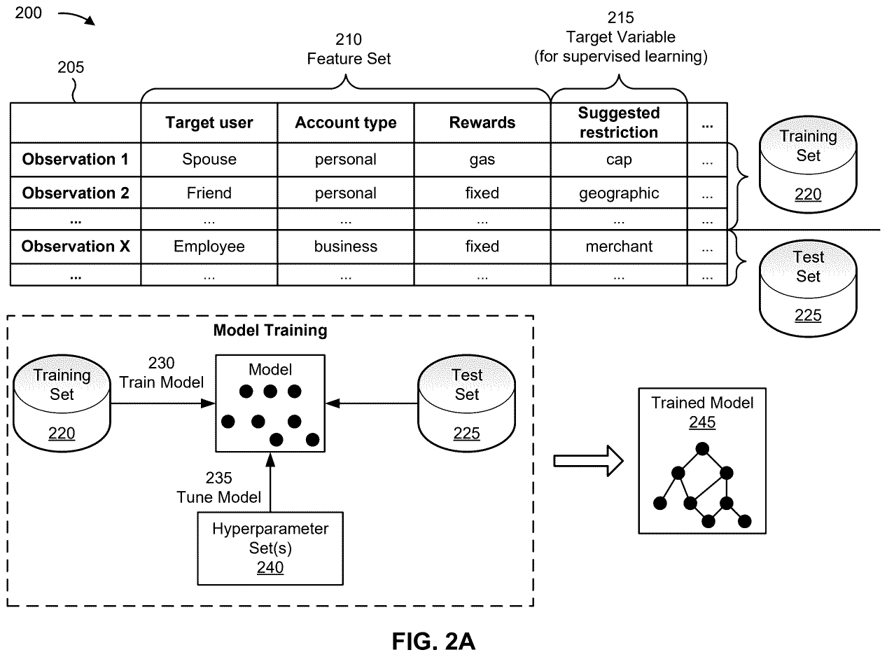

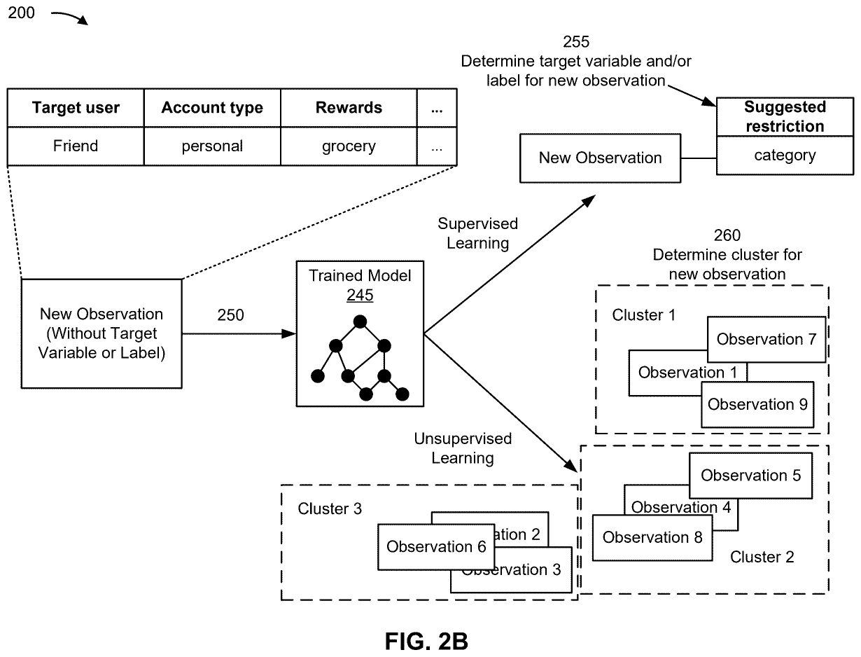

As shown in FIG. 1C, the identifier manager may use the ML model to determine a set of restrictions to apply to the virtual identifier. As shown by reference number 125, the identifier manager may provide the indication of the set of events to the ML model. For example, the identifier manager may transmit, and the ML host associated with the ML model may receive, a request including the indication of the set of events. The ML model may be trained to determine a set of restrictions to apply to the virtual identifier based on the set of events. Additionally, or alternatively, the identifier manager may provide information about the user of the user device and/or information about the target user to the ML model. For example, the identifier manager may transmit, and the ML host associated with the ML model may receive, a request including the information. As described in connection with FIGS. 2A-2B, the ML model may be trained to determine a set of restrictions to apply to the virtual identifier based on the information.

As shown by reference number 130, the ML model may output the set of restrictions to the identifier manager. For example, the ML host associated with the ML model may transmit, and the identifier manager may receive, the set of restrictions to apply to the virtual identifier. The set of restrictions may include a geographic restriction, a merchant restriction, a category restriction, and/or a maximum amount, among other examples.

As shown in FIG. 1D, the user may approve the set of restrictions before the set of restrictions are applied to the virtual identifier. As shown by reference number 135, the identifier manager may transmit, and the user device may receive, an indication of the set of restrictions. The indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image).

As shown by reference number 140, the user device may transmit, and the identifier manager may receive, an approval of the set of restrictions. In some implementations, the user may provide input (e.g., using an input component of the user device) that triggers the user device to transmit the approval. For example, the user device may output (e.g., using an output component of the user device) the indication of the set of restrictions to the user, and the user may interact with the indication in order to provide the input that triggers the user device to transmit the approval. In another example, the indication may include a hyperlink (e.g., a uniform resource locator (URL), among other examples), and the user may use the hyperlink to trigger the user device to transmit the approval (e.g., by causing the user device to transmit an HTTP request based on the hyperlink, where the HTTP request serves as the approval).

As shown in FIG. 1E, the identifier manager may activate the virtual identifier with the set of restrictions (e.g., in response to the approval from the user device). As shown by reference number 145, the identifier manager may generate the virtual identifier. For example, the identifier manager may generate the virtual identifier using pseudo-random number generation and/or algorithmic modification of the permanent identifier associated with the virtual identifier, among other examples.

As shown by reference number 150, the identifier manager may transmit, and the account manager may receive, an instruction to associate the virtual identifier with the permanent identifier. The instruction may also indicate the set of restrictions. For example, as further shown by reference number 150, the identifier manager may transmit, and the account manager may receive, an instruction to apply the set of restrictions to the virtual identifier. In some implementations, the identifier manager may transmit the instruction in response to the approval (from the user device).

The account manager may activate the virtual identifier. Therefore, the account manager may authorize future requests associated with the virtual identifier (e.g., by approving transactions or other events that use the virtual identifier). Additionally, the account manager may apply the set of restrictions to the virtual identifier such that future requests associated with the virtual identifier are approved only if the set of restrictions are met (e.g., transactions or other events that do not satisfy the set of restrictions are denied).

As shown by reference number 155, the account manager may transmit, and the identifier manager may receive, a confirmation that the virtual identifier is active and/or that the set of restrictions was applied. Although the example 100 depicts the identifier manager as separate from the account manager, other examples may include the account manager as at least partially integrated (e.g., virtually, logically, and/or physically) with the identifier manager. Therefore, operations described herein as performed by the account manager may be performed by the identifier manager. For example, the identifier manager may activate the virtual identifier (e.g., such that future requests associated with the virtual identifier are approved) and may apply the set of restrictions (e.g., such that future requests that do not satisfy the set of restrictions are denied). As shown in FIG. 1F and by reference number 160, the identifier manager may forward the confirmation to the user device. The identifier manager may forward the confirmation directly or may re-encode information included in the confirmation received from the account manager into a new envelope that is transmitted to the user device.

As shown by reference number 165, the identifier manager may transmit, and a device associated with the target user (e.g., the target user device) may receive, an indication of the set of restrictions. The indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image). In some implementations, the identifier manager may determine the target user device based on the target user. For example, the identifier manager may map an indicator of the target user (e.g., included in the request from the user device) to an identifier of the target user device. The identifier manager may map a name of the target user and/or a username of the target user to an Internet protocol (IP) address associated with the target user device and/or a medium access control (MAC) address associated with the target user device. Therefore, the identifier manager may transmit the indication to the target user device based on the identifier of the target user device. Alternatively, the identifier manager may transmit the indication to the target user device based on an indication of the target user included in the request from the user device. For example, the identifier manager may directly use an email address associated with the target user to transmit an email message with the indication or may directly use a phone number associated with the target user to transmit a text message with the indication.

Although the example 100 is described in connection with the user approving the set of restrictions, other examples may include the set of restrictions being automatically applied. For example, the identifier manager may automatically apply the set of restrictions based on a setting associated with the user (e.g., a pre-approval of restrictions determined using the ML model). In another example, the identifier manager may automatically apply the set of restrictions and allow the user to remove those restrictions afterward. Accordingly, the identifier manager may transmit, and the user device may receive, the indication of the set of restrictions in response to the confirmation from the account manager.

Additionally with, or alternatively to, the ML model suggesting the set of restrictions during creation of the virtual identifier, the ML model may suggest modifications to the set of restrictions as the virtual identifier is used. Therefore, as shown in FIG. 1G and by reference number 170, the identifier manager may transmit, and the data source may receive, a request for a set of events associated with the virtual identifier. The set of events may include a set of transactions performed using the virtual identifier. For example, the identifier manager may request events authorized by the target user (using the virtual identifier). The request may include an HTTP request, an FTP request, and/or an API call.

As shown by reference number 175, the data source may transmit, and the identifier manager may receive, an indication of the set of events associated with the virtual identifier. The data source may transmit, and the identifier manager may receive, the indication of the set of events in response to the request (from the identifier manager). The indication may include a table (or another type of SQL data structure) or a graph (or another type of NoSQL data structure). The indication may be included in an HTTP response, included in an FTP response, and/or returned from an API function.

The identifier manager may transmit the request periodically (e.g., according to a schedule, whether a default or custom schedule) and/or on demand (e.g., in response to an instruction, such as a command from an administrator). Although the example 100 is described in connection with using a pull to receive the indication of the set of events associated with the virtual identifier, other examples may include use of a push. For example, the identifier manager may transmit, and the data source may receive, a subscription to events associated with the virtual identifier. Accordingly, the data source may transmit, and the identifier manager may receive, the indication of the set of events based on the subscription. For example, the data source may transmit indications of new events as the new events are approved (or encoded and stored at the data source).

As described above, the virtual identifier may be associated with a set of restrictions. Accordingly, as shown in FIG. 1H, the identifier manager may use the ML model to determine a suggested change to the set of restrictions (in other words, a modified restriction to apply to the virtual identifier). As shown by reference number 180, the identifier manager may provide the indication of the set of events to the ML model. For example, the identifier manager may transmit, and the ML host associated with the ML model may receive, a request including the indication of the set of events. The ML model may be trained to determine the suggested change (or the modified restriction) based on the set of events. Additionally, or alternatively, the identifier manager may provide information about the user of the user device and/or information about the target user to the ML model. For example, the identifier manager may transmit, and the ML host associated with the ML model may receive, a request including the information. Accordingly, the ML model may be trained to determine the suggested change (or the modified restriction) based on the information.

As shown by reference number 185, the ML model may output the suggested change (or the modified restriction) to the identifier manager. For example, the ML host associated with the ML model may transmit, and the identifier manager may receive, the suggested change (or the modified restriction).

As shown in FIG. 1I, the identifier manager may apply the modified restriction (e.g., by applying the suggested change to the set of restrictions). As shown by reference number 190, the identifier manager may transmit, and the account manager may receive, an instruction to apply the suggested change to the set of restrictions for the virtual identifier.

The account manager may apply the modified restriction to the virtual identifier such that future requests associated with the virtual identifier are approved only if the modified restriction is met (e.g., transactions or other events that do not satisfy the modified restriction are denied). As shown by reference number 195, the account manager may transmit, and the identifier manager may receive, a confirmation that the suggested change to the set of restrictions was applied. Although the example 100 depicts the identifier manager as separate from the account manager, other examples may include the account manager as at least partially integrated (e.g., virtually, logically, and/or physically) with the identifier manager. Therefore, operations described herein as performed by the account manager may be performed by the identifier manager. For example, the identifier manager may apply the suggested change to the set of restrictions (e.g., such that future requests that do not satisfy the modified restriction are denied).

In some implementations, the identifier manager may forward the confirmation to the user device. The identifier manager may forward the confirmation directly or may re-encode information included in the confirmation received from the account manager into a new envelope that is transmitted to the user device. Additionally, or alternatively, the identifier manager may transmit, and the user device may receive, an indication of the modified restriction in response to the confirmation from the account manager. The indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image). Additionally, or alternatively, the identifier manager may transmit, and a device associated with the target user (e.g., the target user device) may receive, an indication of the modified restriction. The indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image). In some implementations, the identifier manager may determine the target user device based on the target user, as described above.

Although the example 100 is described in connection with the suggested change being automatically applied, other examples may include the user (of the user device) approving the suggested change. For example, the identifier manager may transmit, and the user device may receive, an indication of the modified restriction. The indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image). In response to the indication, the user device may transmit, and the identifier manager may receive, an approval of the modified restriction. In some implementations, the user may provide input (e.g., using an input component of the user device) that triggers the user device to transmit the approval, as described above. Accordingly, the identifier manager may transmit, and the account manager may receive, the instruction to apply the suggested change in response to the approval from the user device.

By using techniques as described in connection with FIGS. 1A-1I, the ML model may suggest the set of restrictions to apply to the virtual identifier. As a result, the ML model reduces risk of compromise for the virtual identifier, which conserves computer resources that otherwise would have been wasted on undoing fraudulent events (e.g., transactions) performed using the virtual identifier. Additionally, accuracy of the ML model may be increased by using the profile that is similar to the profile of the user and/or to the profile of the target user. The ML model may additionally, or alternatively, suggest a modified restriction to apply to the virtual identifier. As a result, the ML model reduces risk of compromise for the virtual identifier, which conserves computer resources that otherwise would have been wasted on undoing fraudulent events (e.g., transactions) performed using the virtual identifier. Because the virtual identifier has been used already, the ML model may use the set of events associated with the virtual identifier to further improve accuracy.

As indicated above, FIGS. 1A-1I are provided as an example. Other examples may differ from what is described with regard to FIGS. 1A-1I.

FIGS. 2A-2B are diagrams illustrating an example 200 of training and using a machine learning model in connection with restrictions on virtual identifiers. The machine learning model training described herein may be performed using a machine learning system. The machine learning system may include or may be included in a computing device, a server, a cloud computing environment, or the like, such as an ML host described in more detail below.

As shown by reference number 205, a machine learning model may be trained using a set of observations. The set of observations may be obtained and/or input from training data (e.g., historical data), such as data gathered during one or more processes described herein. For example, the set of observations may include data gathered from an account manager, as described elsewhere herein. In some implementations, the machine learning system may receive the set of observations (e.g., as input) from a data source.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the data source. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a target user (relative to a user), a second feature of a type of account (to be associated with a virtual identifier), a third feature of a rewards category for the account, and so on. As shown, for a first observation, the first feature may have a value of “Spouse,” the second feature may have a value of “personal,” the third feature may have a value of “gas,” and so on. These features and feature values are provided as examples, and may differ in other examples. For example, the feature set may include one or more of the following features: a set of events (e.g., transactions) authorized by the target user (e.g., with other accounts), a set of events (e.g., transactions) authorized by the user (e.g., using the account and/or an additional account), demographic information (e.g., associated with the user and/or the target user), socioeconomic information (e.g., associated with the user and/or the target user), and/or geographic information (e.g., associated with the user and/or the target user), among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a suggested restriction (for the virtual identifier), which has a value of a monetary cap for the first observation.

The feature set and target variable described above are provided as examples, and other examples may differ from what is described above. For example, for a target variable of a suggested restriction (for the virtual identifier), the feature set may include a set of events (e.g., transactions) authorized by another user with a profile similar to a profile of the user and/or a set of events (e.g., transactions) authorized by another user with a profile similar to a profile of the target user. In another example, for a target variable of a suggested change to a set of restrictions (for the virtual identifier), the feature set may include a set of events (e.g., transactions) associated with the virtual identifier.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that may include a first subset of observations, of the set of observations, and a test set 225 that may include a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

FIG. 2B is a diagram illustrating applying the trained machine learning model 245 to a new observation. As shown by reference number 250, the machine learning system may receive a new observation (or a set of new observations), and may input the new observation to the machine learning model 245. As shown, the new observation may include a first feature of “Friend,” a second feature of “personal,” a third feature of “grocery,” and so on, as an example. The machine learning system may apply the trained machine learning model 245 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 245 may predict a value of a category restriction for the target variable of suggested restriction for the new observation, as shown by reference number 255. Based on this prediction (e.g., based on the value having a particular label or classification or based on the value satisfying or failing to satisfy a threshold), the machine learning system may provide a recommendation and/or output for determination of a recommendation, such as an indication of the category restriction. Additionally, or alternatively, the machine learning system may perform an automated action and/or may cause an automated action to be performed (e.g., by instructing another device to perform the automated action), such as transmitting an instruction to apply the category restriction (e.g., to the account manager). As another example, if the machine learning system were to predict a value of a geographic restriction for the target variable of suggested restriction, then the machine learning system may provide a different recommendation (e.g., an indication of the geographic restriction) and/or may perform or cause performance of a different automated action (e.g., transmitting an instruction to apply the geographic restriction to the account manager). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 245 may classify (e.g., cluster) the new observation in a cluster, as shown by reference number 260. The observations within a cluster may have a threshold degree of similarity. As an example, if the machine learning system classifies the new observation in a first cluster (e.g., associated with a first category of risk), then the machine learning system may provide a first recommendation, such as an indication of a monetary cap. Additionally, or alternatively, the machine learning system may perform a first automated action and/or may cause a first automated action to be performed (e.g., by instructing another device to perform the automated action) based on classifying the new observation in the first cluster, such as transmitting an instruction to apply the monetary cap (e.g., to the account manager). As another example, if the machine learning system were to classify the new observation in a second cluster (e.g., associated with a second category of risk), then the machine learning system may provide a second (e.g., different) recommendation (e.g., an indication of a merchant restriction) and/or may perform or cause performance of a second (e.g., different) automated action, such as transmitting an instruction to apply the merchant restriction (e.g., to the account manager).

The recommendations, actions, and clusters described above are provided as examples, and other examples may differ from what is described above. In this way, the machine learning system may apply a rigorous and automated process to restricting the virtual identifier. The machine learning system may enable recognition and/or identification of tens, hundreds, thousands, or millions of features and/or feature values for tens, hundreds, thousands, or millions of observations, thereby increasing accuracy and consistency and reducing delay associated with determining a set of restrictions (and/or a modification to a set of restrictions). As a result, security is improved for the virtual identifier.

As indicated above, FIGS. 2A-2B are provided as an example. Other examples may differ from what is described in connection with FIGS. 2A-2B. For example, the machine learning model may be trained using a different process than what is described in connection with FIG. 2A. Additionally, or alternatively, the machine learning model may employ a different machine learning algorithm than what is described in connection with FIGS. 2A-2B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram of an example environment 300 in which systems and/or methods described herein may be implemented. As shown in FIG. 3, environment 300 may include an identifier manager 301, which may include one or more elements of and/or may execute within a cloud computing system 302. The cloud computing system 302 may include one or more elements 303-312, as described in more detail below. As further shown in FIG. 3, environment 300 may include a network 320, a user device 330, a data source 340, an ML host 350, an account manager 360, and/or a target user device 370. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the identifier manager 301 may include one or more elements 303-312 of the cloud computing system 302, may execute within the cloud computing system 302, and/or may be hosted within the cloud computing system 302, in some implementations, the identifier manager 301 may not be cloud-based (e.g., may be implemented outside of a cloud computing system) or may be partially cloud-based. For example, the identifier manager 301 may include one or more devices that are not part of the cloud computing system 302, such as device 400 of FIG. 4, which may include a standalone server or another type of computing device. The identifier manager 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with virtual identifiers, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The data source 340 may include one or more devices capable of receiving, generating, storing, processing, and/or providing information associated with events (e.g., transactions), as described elsewhere herein. The data source 340 may include a communication device and/or a computing device. For example, the data source 340 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 340 may communicate with one or more other devices of environment 300, as described elsewhere herein.

The ML host 350 may include one or more devices capable of receiving, generating, storing, processing, and/or providing information associated with machine learning models, as described elsewhere herein. The ML host 350 may include a communication device and/or a computing device. For example, the ML host 350 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 350 may communicate with one or more other devices of environment 300, as described elsewhere herein.

The account manager 360 may include one or more devices capable of processing, authorizing, and/or facilitating an event (e.g., a transaction). For example, the account manager 360 may include one or more servers and/or computing hardware (e.g., in a cloud computing environment or separate from a cloud computing environment) configured to receive and/or store information associated with processing an electronic event. The account manager 360 may process an event, such as to approve (e.g., permit, authorize, or the like) or decline (e.g., reject, deny, or the like) the event and/or to complete the event if the event is approved. The account manager 360 may be associated with a financial institution (e.g., a bank, a lender, a credit card company, or a credit union). For example, the account manager 360 may be associated with an issuing bank and/or an acquiring bank (or merchant bank). The account manager 360 may communicate with one or more other devices of environment 300, as described elsewhere herein.

The target user device 370 may include one or more devices capable of receiving, generating, storing, processing, and/or providing information associated with virtual identifiers, as described elsewhere herein. The target user device 370 may include a communication device and/or a computing device. For example, the target user device 370 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The target user device 370 may execute a digital wallet application or another similar type of application, as described herein. The target user device 370 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with changing restrictions on virtual identifiers. The device 400 may correspond to a user device 330, a data source 340, an ML host 350, an account manager 360, and/or a target user device 370. In some implementations, a user device 330, a data source 340, an ML host 350, an account manager 360, and/or a target user device 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection).

The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

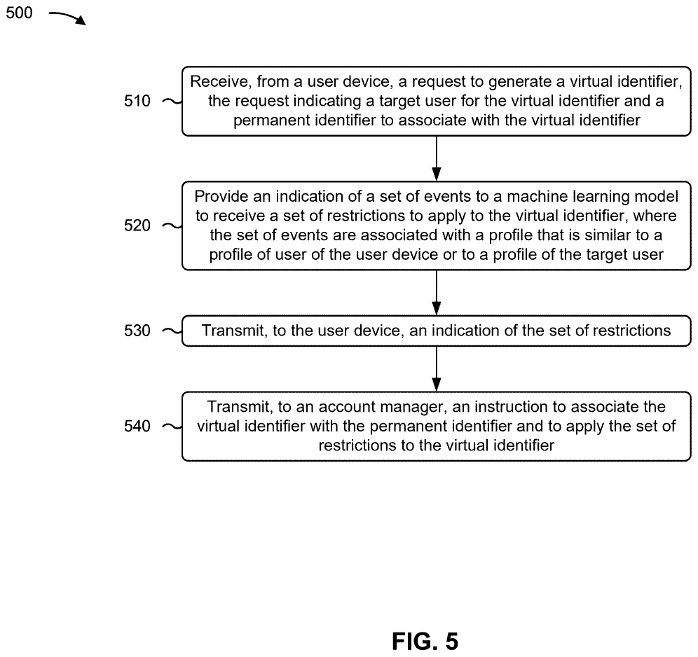

FIG. 5 is a flowchart of an example process 500 associated with adding restrictions to virtual identifiers. In some implementations, one or more process blocks of FIG. 5 may be performed by an identifier manager 301. In some implementations, one or more process blocks of FIG. 5 may be performed by another device or a group of devices separate from or including the identifier manager 301, such as a user device 330, a data source 340, an ML host 350, an account manager 360, and/or a target user device 370. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a request to generate the virtual identifier, the request indicating a target user for the virtual identifier and a permanent identifier to associate with the virtual identifier (block 510). For example, the identifier manager 301 (e.g., using processor 420, memory 430, and/or communication component 460) may receive, from a user device, a request to generate the virtual identifier, the request indicating a target user for the virtual identifier and a permanent identifier to associate with the virtual identifier, as described above in connection with reference number 110 of FIG. 1A. As an example, the request may include a name, an email address, and/or a phone number associated with the target user, among other examples. Additionally, the request may include a token including an encrypted version of the permanent identifier. In another example, the request may include an index or another type of identifier that indicates the permanent identifier from a set of possible permanent identifiers (e.g., from a set of accounts). Alternatively, the request may indicate the permanent identifier implicitly rather than explicitly. For example, the request may be associated with the set of credentials, and the set of credentials may be associated with the permanent identifier (e.g., at a data structure stored, or at least accessible, by the identifier manager 301).

As further shown in FIG. 5, process 500 may include providing an indication of a set of events to a machine learning model to receive a set of restrictions to apply to the virtual identifier, where the set of events are associated with a profile that is similar to a profile of a user of the user device or to a profile of the target user (block 520). For example, the identifier manager 301 (e.g., using processor 420, memory 430, and/or communication component 460) may provide an indication of a set of events to a machine learning model to receive a set of restrictions to apply to the virtual identifier, where the set of events are associated with a profile that is similar to a profile of a user of the user device or to a profile of the target user, as described above in connection with FIG. 1C. As an example, the machine learning model may be trained to determine the set of restrictions to apply to the virtual identifier based on the set of events. Additionally, or alternatively, the identifier manager 301 may provide information about a user of the user device and/or information about the target user to the machine learning model. Accordingly, as described in connection with FIGS. 2A-2B, the machine learning model may be trained to determine the set of restrictions to apply to the virtual identifier based on the information.

As further shown in FIG. 5, process 500 may include transmitting, to the user device, an indication of the set of restrictions (block 530). For example, the identifier manager 301 (e.g., using processor 420, memory 430, and/or communication component 460) may transmit, to the user device, an indication of the set of restrictions, as described above in connection with reference number 135 of FIG. 1D. As an example, the indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image).

As further shown in FIG. 5, process 500 may include transmitting, to an account manager, an instruction to associate the virtual identifier with the permanent identifier and to apply the set of restrictions to the virtual identifier (block 540). For example, the identifier manager 301 (e.g., using processor 420, memory 430, and/or communication component 460) may transmit, to an account manager, an instruction to associate the virtual identifier with the permanent identifier and to apply the set of restrictions to the virtual identifier, as described above in connection with reference number 150 of FIG. 1E. As an example, the identifier manager 301 may transmit the instruction in response to an approval of the set of restrictions (e.g., received from the user device). The account manager may activate the virtual identifier and apply the set of restrictions to the virtual identifier (e.g., such that transactions or other events, associated with the virtual identifier, are approved only if the set of restrictions are satisfied).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1I and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

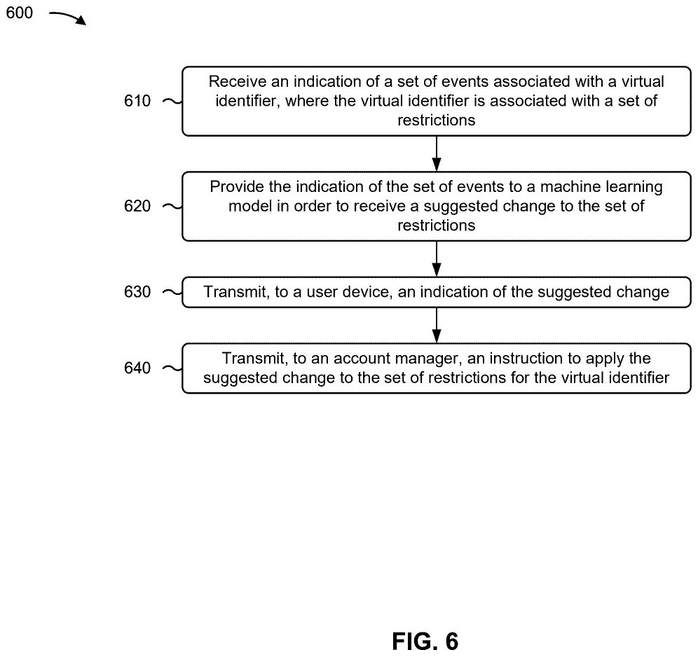

FIG. 6 is a flowchart of an example process 600 associated with changing restrictions on virtual identifiers. In some implementations, one or more process blocks of FIG. 6 may be performed by an identifier manager 301. In some implementations, one or more process blocks of FIG. 6 may be performed by another device or a group of devices separate from or including the identifier manager 301, such as a user device 330, a data source 340, an ML host 350, an account manager 360, and/or a target user device 370. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include receiving an indication of a set of events associated with the virtual identifier, where the virtual identifier is associated with a set of restrictions (block 610). For example, the identifier manager 301 (e.g., using processor 420, memory 430, and/or communication component 460) may receive an indication of a set of events associated with the virtual identifier, where the virtual identifier is associated with a set of restrictions, as described above in connection with reference number 175 of FIG. 1G. As an example, the identifier manager 301 may receive the indication of the set of events in response to a request (e.g., transmitted by the identifier manager 301). The indication may include a table (or another type of SQL data structure) or a graph (or another type of NoSQL data structure).

As further shown in FIG. 6, process 600 may include providing the indication of the set of events to a machine learning model in order to receive a suggested change to the set of restrictions (block 620). For example, the identifier manager 301 (e.g., using processor 420, memory 430, and/or communication component 460) may provide the indication of the set of events to a machine learning model in order to receive a suggested change to the set of restrictions, as described above in connection with FIG. 1H. As an example, the machine learning model may be trained to determine the suggested change based on the set of events.

Additionally, or alternatively, the identifier manager 301 may provide information about a user that requested the virtual identifier and/or information about a target user of the virtual identifier to the machine learning model. Accordingly, the machine learning model may be trained to determine the suggested change based on the information.

As further shown in FIG. 6, process 600 may include transmitting, to a user device, an indication of the suggested change (block 630). For example, the identifier manager 301 (e.g., using processor 420, memory 430, and/or communication component 460) may transmit, to a user device, an indication of the suggested change, as described above in connection with FIG. 1I. As an example, the indication may be included in an email message (e.g., as text and/or an image), a text message (e.g., as text or in a webpage accessible by a hyperlink in the text message), a push notification (e.g., as text or accessible via an application executed by the user device), or instructions for a UI (e.g., including the indication as text and/or an image).

As further shown in FIG. 6, process 600 may include transmitting, to an account manager, an instruction to apply the suggested change to the set of restrictions for the virtual identifier (block 640). For example, the identifier manager 301 (e.g., using processor 420, memory 430, and/or communication component 460) may transmit, to an account manager, an instruction to apply the suggested change to the set of restrictions for the virtual identifier, as described above in connection with reference number 190 of FIG. 1I. As an example, the identifier manager 301 may transmit the instruction in response to an approval of the suggested change (e.g., received from the user device). The account manager may apply the suggested change to the set of restrictions (e.g., such that transactions or other events, associated with the virtual identifier, are approved only if a modified restriction is satisfied).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1I and/or FIGS. 2A-2B. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c”is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for managing restrictions on a virtual identifier, the system comprising:
one or more memories; and
one or more processors, communicatively coupled to the one or more memories, configured to:
receive, from a user device, a request to generate the virtual identifier, wherein the request indicates a target user for the virtual identifier and a permanent identifier to associate with the virtual identifier;
determine, using a machine learning model, a set of restrictions to apply to the virtual identifier;
transmit, to the user device, an indication of the set of restrictions;
receive, from the user device, an approval of the set of restrictions;
activate the virtual identifier with the set of restrictions;
receive an indication of a set of events associated with the virtual identifier;
provide the indication of the set of events to the machine learning model in order to receive a modified restriction;
transmit, to the user device, an indication of the modified restriction;
receive, from the user device, an approval of the modified restriction; and
apply the modified restriction to the virtual identifier.

2. The system of claim 1, wherein the one or more processors are configured to:
transmit, to a device associated with the target user, the indication of the set of restrictions.

3. The system of claim 1, wherein the one or more processors are configured to:
transmit, to a device associated with the target user, the indication of the modified restriction.

4. The system of claim 1, wherein the one or more processors, to activate the virtual identifier, are configured to:
transmit, to an account manager, an instruction to associate the virtual identifier with the permanent identifier,
wherein the instruction indicates the set of restrictions.

5. The system of claim 1, wherein the one or more processors, to apply the modified restriction to the virtual identifier, are configured to:
transmit, to an account manager, an instruction that indicates the modified restriction.

6. The system of claim 1, wherein the one or more processors, to provide the indication of the set of events to the machine learning model, are configured to:
transmit, to a machine learning host associated with the machine learning model, a request including the indication of the set of events,
wherein the modified restriction is received from the machine learning host.

7. A method of initiating restrictions on a virtual identifier, comprising:
receiving, from a user device and at an identifier manager, a request to generate the virtual identifier, wherein the request indicates a target user for the virtual identifier and a permanent identifier to associate with the virtual identifier;
providing an indication of a set of events to a machine learning model to receive a set of restrictions to apply to the virtual identifier, wherein the set of events are associated with a profile that is similar to a profile of a user of the user device or to a profile of the target user;
transmitting, from the identifier manager and to the user device, an indication of the set of restrictions; and
transmitting, from the identifier manager and to an account manager, an instruction to associate the virtual identifier with the permanent identifier and to apply the set of restrictions to the virtual identifier.

8. The method of claim 7, wherein the indication of the set of restrictions is included in an email message, a text message, a push notification, or instructions for a user interface.

9. The method of claim 7, further comprising:
verifying a set of credentials associated with the user of the user device,
wherein the request to generate the virtual identifier is received based on verifying the set of credentials.

10. The method of claim 7, further comprising:
receiving, at the identifier manager and from the user device, an approval of the set of restrictions,
wherein the instruction to apply the set of restrictions to the virtual identifier is transmitted in response to the approval.

11. The method of claim 7, further comprising:
receiving, at the identifier manager and from the account manager, a confirmation that the set of restrictions was applied,
wherein the indication of the set of restrictions is transmitted to the user device in response to the confirmation.

12. The method of claim 7, wherein the set of restrictions includes a geographic restriction, a merchant restriction, a category restriction, or a maximum amount.

13. The method of claim 7, wherein providing the indication of the set of events to the machine learning model comprises:
transmitting, from the identifier manager and to a machine learning host associated with the machine learning model, a request including the indication of the set of events,
wherein the set of restrictions are received from the machine learning host.

14. A non-transitory computer-readable medium storing a set of instructions for adjusting restrictions on a virtual identifier, the set of instructions comprising:
one or more instructions that, when executed by one or more processors of a device, cause the device to:
receive an indication of a set of events associated with the virtual identifier, wherein the virtual identifier is associated with a set of restrictions;
provide the indication of the set of events to a machine learning model in order to receive a suggested change to the set of restrictions;
transmit, to a user device, an indication of the suggested change; and
transmit, to an account manager, an instruction to apply the suggested change to the set of restrictions for the virtual identifier.

15. The non-transitory computer-readable medium of claim 14, wherein the indication of the suggested change is included in an email message, a text message, a push notification, or instructions for a user interface.

16. The non-transitory computer-readable medium of claim 14, wherein the one or more instructions, when executed by the one or more processors, cause the device to:
transmit, to a data source, a request for the set of events,
wherein the indication of the set of events is received from the data source in response to the request.

17. The non-transitory computer-readable medium of claim 14, wherein the one or more instructions, when executed by the one or more processors, cause the device to:
transmit, to a data source, a subscription to events associated with the virtual identifier,
wherein the indication of the set of events is received from the data source based on the subscription.

18. The non-transitory computer-readable medium of claim 14, wherein the one or more instructions, when executed by the one or more processors, cause the device to:
receive, from the account manager, a confirmation that the suggested change was applied,
wherein the indication of the suggested change is transmitted to the user device in response to the confirmation.

19. The non-transitory computer-readable medium of claim 14, wherein the one or more instructions, when executed by the one or more processors, cause the device to:
receive, from the user device, an approval of the suggested change,
wherein the instruction to apply the suggested change is transmitted in response to the approval of the suggested change.

20. The non-transitory computer-readable medium of claim 14, wherein the one or more instructions, that cause the device to provide the indication of the set of events to the machine learning model, cause the device to:
transmit, to a machine learning host associated with the machine learning model, a request including the indication of the set of events,
wherein the suggested change to the set of restrictions is received from the machine learning host.
